(19) United States
(12) Patent Application Publication
(10) Pub. No.: US 2026/0295420 A1
(43) Pub. Date: Oct. 1, 2026

(54) ONE OR MORE COMPUTER-READABLE STORAGE MEDIA, INFORMATION PROCESSING SYSTEM, AND COMPUTER-IMPLEMENTED METHOD

(71) Applicant: NINTENDO CO., LTD., Kyoto (JP)

(72) Inventor: Kenta ISASAKA, Kyoto (JP)

(21) Appl. No.: 19/572,361

(22) Filed: Mar. 19, 2026

(30) Foreign Application Priority Data
Mar. 27, 2025 (JP) 2025-053532

(51) Int. Cl. A63F 13/56; A63F 13/57; A63F 13/803; G06F 7/58

(52) U.S. Cl. CPC A63F 13/56; A63F 13/57; A63F 13/803; G06F 7/588

(57) ABSTRACT

An example of an information processing system of the exemplary embodiment performs movement control for a player object on a field in a virtual space, based on an operation input. On the field, a plurality of weather areas for which virtual weather parameters are respectively set, are defined. When the player object is positioned within one of the weather areas, a first-type wave, on which the player object can ride and whose position and state are determined according to a first determination method at least based on the weather parameter set for the weather area and an elapsed time, is generated and controlled within the area.

### CROSS REFERENCE TO RELATED APPLICATION

This application claims priority to Japanese Patent Application No. 2025-053532, filed on Mar. 27, 2025, the entire contents of which are incorporated herein by reference.

### FIELD

The technique shown here relates to one or more computer-readable storage media having stored therein a game program, an information processing system, a computer-implemented method, and an information processing apparatus that enable execution of a racing game.

### BACKGROUND AND SUMMARY

Conventionally, there has been a game in which a race is conducted on a course where terrain movement is determined in advance.

In the conventional game, the terrain movement is determined for each course.

The exemplary embodiment discloses a game program, an information processing system, a computer-implemented method, an information processing system, and an information processing apparatus that, in a game in which races are conducted on courses set at various locations on a field, enable setting of appropriate waves based on each location on the field.

The exemplary embodiment adopts the following configurations.

### First Configuration

A first configuration of the exemplary embodiment is one or more non-transitory computer-readable storage media having stored therein instructions that, when executed, cause one or more processors to execute game processing comprising:
on a field in a virtual space, performing movement control for a player object based on an operation input, the field including a plurality of weather areas for which virtual weather parameters are respectively set;
when the player object is positioned within one of the weather areas, generating and controlling, within the area, a first-type wave on which the player object can ride, and whose position and state are determined according to a first determination method at least based on the weather parameter set for the weather area and an elapsed time; and
when an instruction to start a race involving the player object and a plurality of opponent objects is made,
setting, on the field, a course to be used for the race among a plurality of courses respectively defined in partial regions of the field, and starting the race, and
during the race, on the field, performing the movement control for the player object and movement control for the opponent objects along the course.

With the above configuration, in a game in which races are conducted at various locations on the field, waves can be appropriately set based on the area of the field.

### Second Configuration

In a second configuration based on the first configuration, the race may include a competitive race involving a plurality of players, based on communication with a computer of another player. The game processing may further comprise, when an instruction to start the competitive race is made, generating and controlling the first-type wave according to the first determination method, at least based on the weather parameter for each weather area that is shared with the computer of the other player in the competitive race, and the elapsed time that is synchronized with the computer of the other player in the competitive race.

With the above configuration, in the competitive race involving a plurality of players, control can be performed such that the same wave is generated at the same location at the same timing, thereby enabling a fair race.

### Third Configuration

In a third configuration based on the second configuration, the first determination method may be a method for determining the position and state of the first-type wave, further based on random-number generation data. The game processing may further comprise, in the competitive race, generating and controlling the first-type wave according to the first determination method, further based on the random-number generation data that is shared with the computer of the other player.

With the above configuration, the same wave with randomness can be generated for each player.

### Fourth Configuration

In a fourth configuration based on the second configuration, the game processing may further comprise, when a first action instruction based on an operation input is made at a timing when the player object moves and leaps over the wave, causing the player object to perform a first action, and temporarily accelerating the player object.

With the above configuration, the wave can be used for movement control for the player object. The wave that provides an advantageous effect in the competitive race can be generated and controlled fairly.

### Fifth Configuration

In a fifth configuration based on the fourth configuration, the game processing may further comprise rendering, as whitecaps, a range along a ridge-line portion of the wave.

With the above configuration, the position where the player object can perform the first action can be made visually understandable.

### Sixth Configuration

In a sixth configuration based on any one of the second to fifth configurations, the game processing may further comprise, during the competitive race, generating a first event, and generating and controlling a second-type wave on which the player object can ride, and whose position and state are determined based on an occurrence timing of the first event that is shared with the computer of the other player and the elapsed time that is synchronized with the computer of the other player.

With the above configuration, the second-type wave different from the wave due to the weather parameter can be generated, and the second-type wave can be synchronized among the players.

### Seventh Configuration

In a seventh configuration based on the sixth configuration, the first event may be an object on the field performing a second action, and the second-type wave may be a wave that is generated at a timing when the second action is performed, at a position where the second action is performed, and moves based on the elapsed time.

With the above configuration, the second-type wave can be generated by the second action performed by the object on the field.

### Eighth Configuration

In an eighth configuration based on any one of the first to seventh configurations, on the field, a whirlpool type wave may be further arranged. The wave may include crest portions forming a plurality of spiral-shaped ridgelines, and may have a flow that controls the player object to move toward a center portion.

With the above configuration, the whirlpool type wave can be further generated.

### Ninth Configuration

In a ninth configuration based on any one of the first to eighth configurations, the weather parameter may include at least a direction and strength of a wind that is virtually set in the weather area. The game processing may further comprise, in the weather area including the player object, generating and controlling the first-type wave, based on the direction and strength of the wind, and generating an effect of the virtual wind within the virtual space.

With the above configuration, the wave can be generated and controlled according to the virtual wind.

Another configuration may be an information processing system, an information processing apparatus, or a computer-implemented method for executing the above game program.

According to the exemplary embodiment, in a game in which races are conducted at various locations on the field, waves can be appropriately set based on areas of the field.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the entirety of a field F in a virtual space;

FIG. 4 is an example non-limiting diagram showing an example of a game image displayed when a race is conducted on a course C12 including a land 50 and a river 41;

FIG. 5 is an example non-limiting diagram showing an example of a game image displayed when a race is conducted on a course C3 including a sea 40;

FIG. 6 is an example non-limiting diagram showing an example of a game image when a player object 70 performs a jump action;

FIG. 7 is an example non-limiting diagram illustrating generation and control of first-type waves;

FIG. 8 is an example non-limiting diagram showing the shape of a water surface when each point V of the water surface is displaced from its initial state;

FIG. 9 is an example non-limiting diagram illustrating a method for rendering a whitecap portion;

FIG. 10 is an example non-limiting diagram showing an example of a plurality of weather areas defined on the field;

FIG. 11 is an example non-limiting diagram showing an example of game images before and after the player object 70 enters the second weather area;

FIG. 12 is an example non-limiting diagram showing an example of a second-type wave that is caused by a bomb item launched by a player object;

FIG. 13 is an example non-limiting diagram showing an example of a second-type wave that is caused by an action performed by a cloud object placed in the virtual space;

FIG. 14 is an example non-limiting diagram showing an example of a whirlpool 47 placed at a predetermined position in the sea 40;

FIG. 15 is an example non-limiting diagram showing an example of various data stored in a game system 1;

FIG. 16 is an example non-limiting flowchart showing an example of game processing; and

FIG. 17 is an example non-limiting flowchart showing an example of a wave control process in step S17.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an upper button, a lower button, a right button, and a left button, a plurality of buttons (an A-button, a B-button, an X-button, a Y-button, an L-button, and an R-button) and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

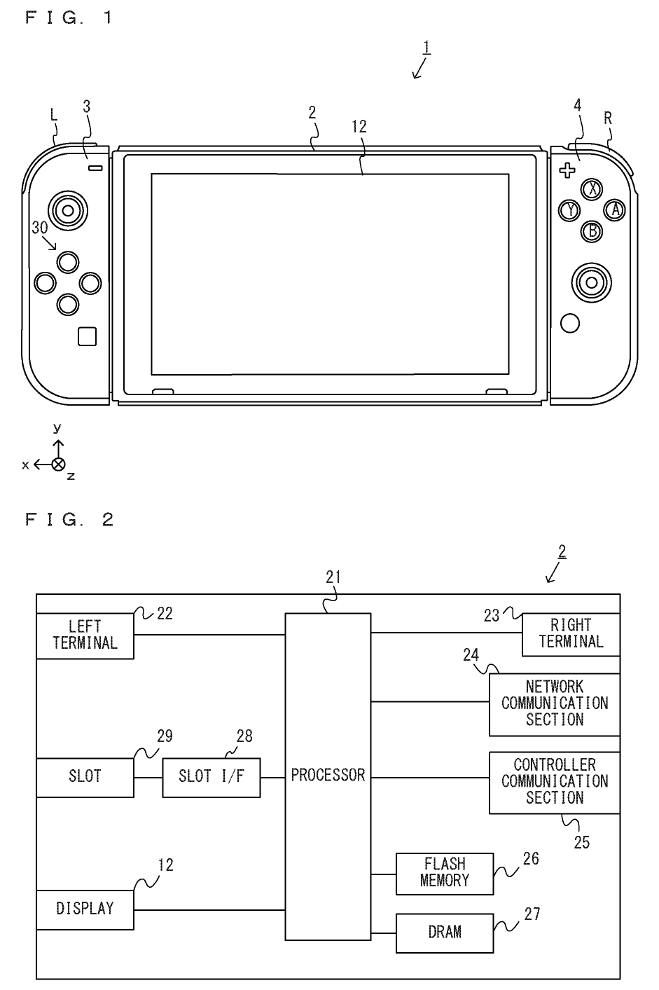

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Outline of Game

Next, the outline of a game executed in the game system 1 will be described. The game of the exemplary embodiment is a racing game in which a plurality of mobile objects are moved in a three-dimensional virtual space (game space).

For example, a main body apparatus 2 communicates with another main body apparatus 2 via a network (e.g., the Internet), whereby a plurality of players play a racing game in a multiplayer mode. Hereinafter, a case where a racing game is played in a multiplayer mode will be described. A single player may play a racing game in a single-player mode.

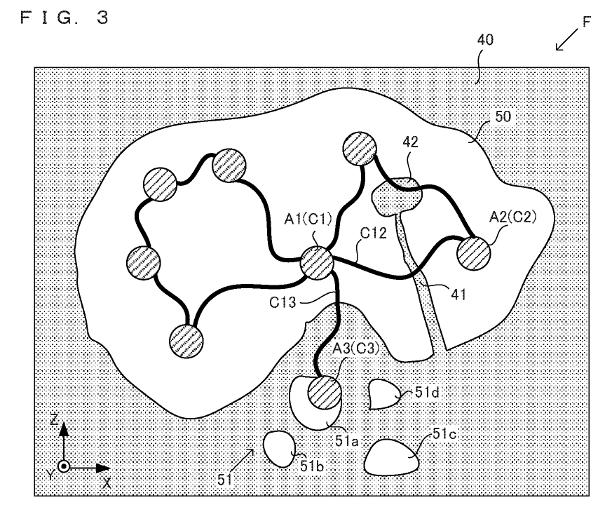

First, a field in a virtual space where the game of the exemplary embodiment is performed will be described. FIG. 3 shows an example of a field F in the virtual space. A Y-axis in the height direction and an X-axis and a Z-axis perpendicular to the Y-axis are set in the virtual space.

In the exemplary embodiment, a vast field F is set in the virtual space. As shown in FIG. 3, the field F includes, for example, a sea 40, a river 41, a lake 42, a land 50, and a plurality of islands 51 (e.g., 51a to 51d).

On the field F, a plurality of base areas A (circles in FIG. 3) are set. When a plurality of mobile objects participate in a race, a course used for the race is set on the field. Based on a selection operation performed by the player, one of a plurality of courses respectively defined in partial regions of the field is selected, and the racing game is played on the selected course. The course selection may be automatically performed by the game system 1 or the server.

The plurality of courses include courses set in the respective base areas A, and courses connecting the base areas. For example, there is a case where a course C1 is set in a base area A1, and a race is conducted on the course C1. The course C1 is, for example, a course that is set along a road set in a grassland region of the land 50. There is a case where a course C12 is set between the base area A1 and a base area A2. The course C12 is, for example, a course that starts from a starting point in the base area A1, passes through the grassland region between the base area A1 and the base area A2, passes over the water surface of the river 41, and reaches a goal point in the base area A2. There is a case where a course C3 is set in a base area A3 consisting of a plurality of islands 51. The course C3 is, for example, a course including a route in which mobile objects travel on the ground of the plurality of islands 51, and a route in which mobile objects travel on the water surface of the sea 40 between the islands. There is a case where a course C13 is set between the base area A1 and the base area A3. The course C13 is, for example, a course that starts from the starting point in the base area A1, passes through the water surface of the sea 40, and reaches the goal point in the base area A3 (in the island 51a). Thus, in the race of the exemplary embodiment, a plurality of mobile objects travel on the ground and/or the water surface depending on the course that is set.

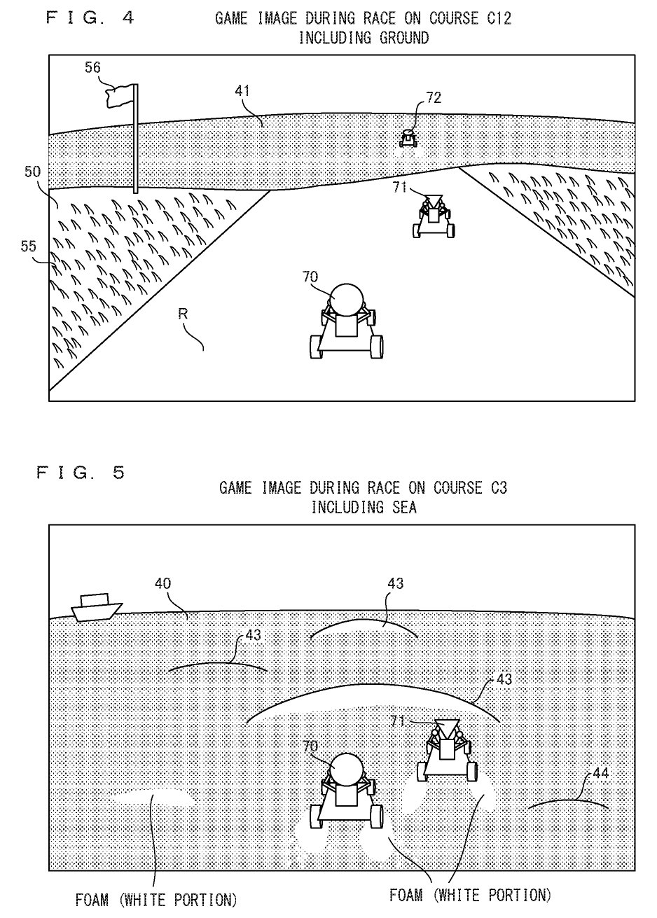

FIG. 4 shows an example of a game image displayed when a race is conducted on the course C12 including the land 50 and the river 41.

As shown in FIG. 4, a plurality of mobile objects (each including a vehicle object and a character) including a player object 70 move along the course C12 set in the field. The course C12 is a course including the grassland region of the land 50, and the river 41. In the grassland region, grass 55 is growing, and the player object 70 and an opponent object 71 travel on a road R set on the grassland region. The player object 70 is a mobile object that is operated by a first player of the main body apparatus 2, and movement thereof is controlled based on operation data from the controllers 3 and 4. A virtual camera that moves to follow the player object 70 is disposed at a predetermined position behind the player object 70, and a game image is generated based on the virtual camera and is displayed on a display device (display 12 or another display device).

The opponent object 71 is a mobile object that is operated by a second player, for example, and movement thereof is controlled based on game data received from the main body apparatus 2 of the second player.

Ahead of the opponent object 71, the river 41 flows, and each mobile object travels on the river 41. Ahead of the opponent object 71, an opponent object 72 is traveling on the river 41. The opponent object 72 is a mobile object that is operated by a third player, for example, and movement thereof is controlled based on game data received from the main body apparatus 2 of the third player. In addition to the opponent objects 71 and 72, opponent objects operated by a plurality of other players participate in the racing game. At least one of the plurality of opponent objects may be a mobile object (non-player object) automatically controlled by the processor 21.

When the racing game is played on the course C12, the plurality of mobile objects including the player object 70 travel on the ground, such as the road R or the region where the grass 55 is growing, and travel on the water surface of the river 41, to reach the goal point of the course C12. The phrase “a mobile object travels on the water surface” means that the mobile object moves in a state where the entirety thereof is above the water surface, and that the mobile object moves in a state where a part thereof (e.g., tires or a part of the body of the vehicle object) is under the water while the other part is above the water surface.

The river 41 flows in a fixed direction (e.g., from the left to right in FIG. 4), and when a mobile object is stationary on the river 41, the mobile object is carried away in the fixed direction.

Furthermore, in the virtual space, wind is blowing. For example, in FIG. 4, wind is blowing from right to left, and due to the wind, the grass 55 and a flag 56 are fluttering. In the exemplary embodiment, a plurality of weather areas are defined in the virtual space, and a weather parameter indicating the strength and direction of the wind is set for each weather area. Based on the weather parameter set for each weather area, wind effects (e.g., the grass 55 and the flag 56 fluttering) are generated, and first-type waves are generated at the water surface of the river 41, the sea 40, or the like. Hereinafter, control for the first-type waves will be described.

### Generation/Control of First-Type Waves

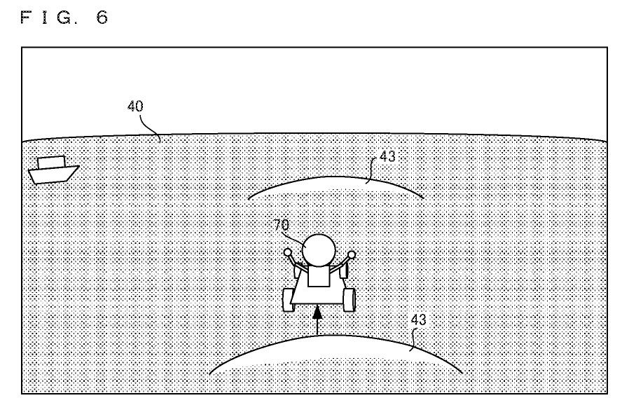

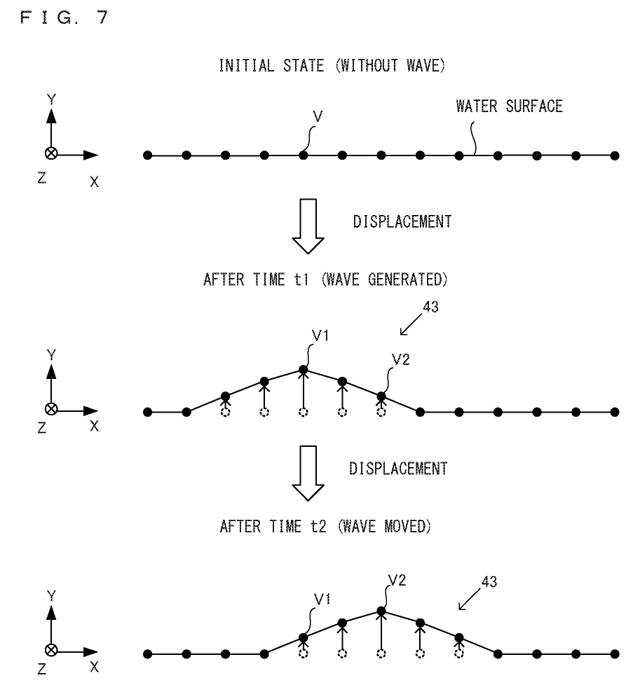

FIG. 5 shows an example of a game image that is displayed when a race is conducted on the course C3 including the sea 40.

As shown in FIG. 5, when a racing game is played on the course C3, a plurality of mobile objects including the player object 70 travel on the water surface of the sea 40. At the water surface, waves that the player object 70 can ride are generated. For example, first-type waves 43 are generated and controlled in the sea 40. The first-type waves 43 are waves controlled based on the weather parameters set for the weather areas, and are relatively high waves. The position of the crest of each first-type waves 43 moves over time. For example, the crest of each first-type wave 43 moves in a direction opposite to the traveling direction of the player object 70 and the opponent object 71 shown in FIG. 5 (from the back of the page toward the front in FIG. 5). Each first-type wave 43 includes a whitecap portion (white-painted portion).

In the sea 40, a wave 44 lower than the first-type waves 43 may be generated. The low wave 44 is also a wave that the player object 70 can ride, and is a first-type wave controlled based on the weather parameters.

The relatively high first-type wave 43 affects traveling of each mobile object. Specifically, each mobile object can perform a jump action when passing through the first-type wave 43.

FIG. 6 shows an example of a game image when the player object 70 performs a jump action. As shown in FIG. 6, for example, when a jump action instruction is made by the first player at the timing when the player object 70 is about to leap over the crest of the first-type wave 43, the player object 70 performs a jump action. For example, as a jump action, the player object 70 may spread both arms, face toward the virtual camera, or strike a predetermined pose. When the player object 70 performs a jump action, the player object 70 is temporarily accelerated. Specifically, the traveling speed after landing from the jump action is temporarily increased. Aa a result, the player object 70 enters a temporarily advantageous state in the racing game.

On the other hand, when the player object 70 passes the low wave 44, the player object 70 cannot perform a jump action. Whether the player object 70 can perform a jump action is determined based on the wave height, the inclination angle, the speed of the player object 70, etc.

In the exemplary embodiment, a portion of the first-type wave 43 on which the player object 70 can perform a jump action is rendered as whitecaps. The whitecaps allow the player to judge whether a jump action is possible. Since white portions of waves represent foam, as shown in FIG. 5, there may be white portions at the water surface that differ from the whitecaps indicating that the player object 70 can perform a jump action. Such white portions are generated after a mobile object has passed or after a first-type wave 43 has attenuated and disappeared, and appear and disappear over time. When the player object 70 passes through the white portions, the player object 70 cannot perform a jump action.

There are also locations on the ground of the field where raised portions having a predetermined height and inclination angle, on which the player object 70 can perform a jump action, are provided. When a jump action instruction is made at the timing when the player object 70, traveling at a predetermined speed or more, is about to leap over the raised portion on the ground, the player object 70 performs a jump action.

Next, generation and control of a first-type wave will be specifically described. FIG. 7 illustrates generation and control of a first-type wave. FIG. 7 is a view when the water surface is seen in a direction parallel to the XZ plane.

The shape of the water surface (sea surface, river surface, or lake surface) is defined by a plurality of points V and polygonal faces composed of the points V. As shown in FIG. 7, in the initial state, there are no waves, and the water surface is, for example, a plane parallel to the XZ plane. Each point V on the water surface is displaced by a first determination method based on the weather parameter set for the weather area where the player object 70 is present, the elapsed time from a predetermined start timing, and random-number generation data. For example, waves may be generated and controlled by displacing each point on the water surface, based on a periodic function that has, as variables, at least the weather parameter, the elapsed time from the predetermined start timing, and the random-number generation data.

For example, when time t1 has elapsed from the predetermined start timing, a plurality of points V are displaced, whereby a first-type wave 43 is generated. In FIG. 7, each point V on the water surface is displaced in the Y-axis direction (height direction), but each point V may be displaced in the X-axis direction and the Z-axis direction.

Here, the elapsed time from the predetermined start timing is synchronized among a plurality of main body apparatuses 2. For example, the predetermined start timing may be the start timing of a racing game. The predetermined start timing may be the start timing of a session of a multiplayer game. A “session” is generated when a game is played among a plurality of main body apparatuses 2. The plurality of main body apparatuses 2 share the same session ID, and communicate with each other based on the session ID. Specifically, when a racing game is played among a plurality of main body apparatuses 2, each main body apparatus 2 transmits a participation request for a multiplayer game to the server on the Internet. The server matches a plurality of players in response to the participation requests from the respective main body apparatuses 2, and transmits a session ID to the main body apparatus 2 of each matched player. A multiplayer game session is started by the respective main body apparatuses 2 establishing communication (P2P communication) with one another based on the session ID received from the server. When a predetermined time has elapsed from the start of the session, the racing game is started. Thus, the predetermined start timing is synchronized among the respective main body apparatuses 2.

The random-number generation data is data for generating random numbers, and is shared among the respective main body apparatuses 2. As one example, the random-number generation data is a seed value for the random numbers. That is, each main body apparatus generates random numbers by a common random-number generation method based on the seed value. By sharing the seed value in advance, it is possible to generate the same random numbers on each main body apparatus while maintaining randomness. Since the first-type waves are generated and controlled based on the random numbers generated using the random-number generation data, it is possible to generate waves that exhibit randomness. For example, when the multiplayer game session is started, the server or one of the plurality of main body apparatuses 2 may generate random-number generation data, and the generated random-number generation data may be shared by the respective main body apparatuses 2. Alternatively, when the racing game is started, random-number generation data may be generated and shared by the plurality of main body apparatuses 2.

When time t2 (>t1) has elapsed from the predetermined start timing, the displacement of each point V changes. For example, at point V1, the displacement is largest at time t1, forming the crest of the first-type wave 43, but the displacement becomes smaller at time t2. Meanwhile, the displacement at point V2 becomes larger at time t2 than at time t1, and at time t2, point V2 forms the crest of the first-type wave 43. Thus, as each point on the water surface undergoes periodic displacement over time, (the crest of) the first-type wave 43 moves across the water surface.

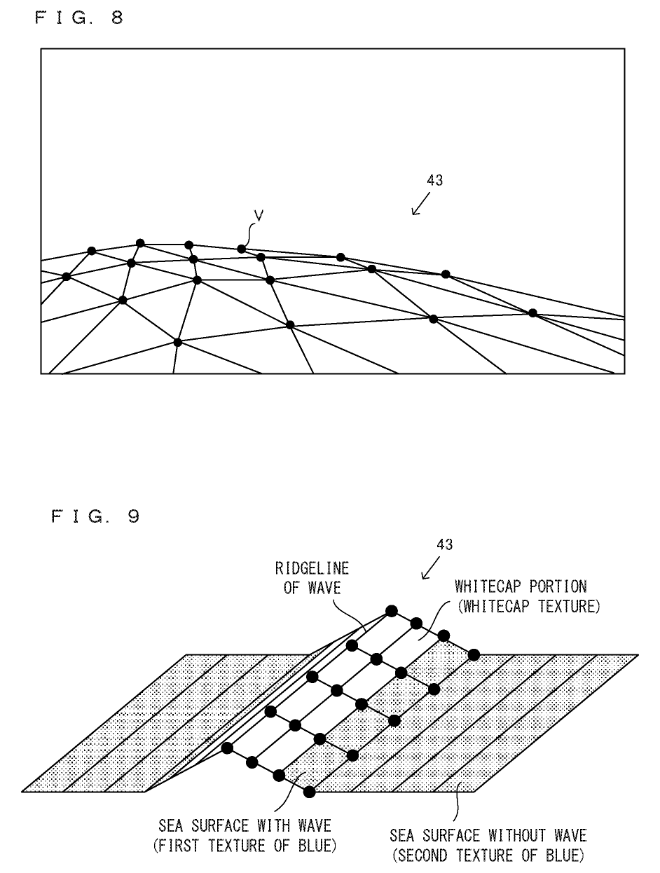

FIG. 8 shows the shape of a water surface when each point V on the water surface is displaced from its initial state. As shown in FIG. 8, by displacing each point V at least in the height direction, the shape of the water surface changes. By periodically displacing each point V in accordance with the elapsed time, the shape of the water surface changes over time, and is formed as a first-type wave 43. By applying a texture image representing the water surface to the water-surface shape formed by displacing each point V, a wavy water surface is rendered.

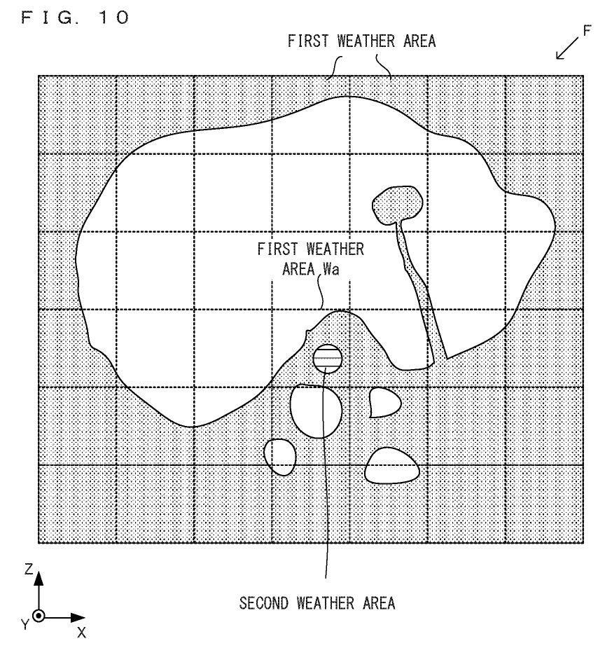

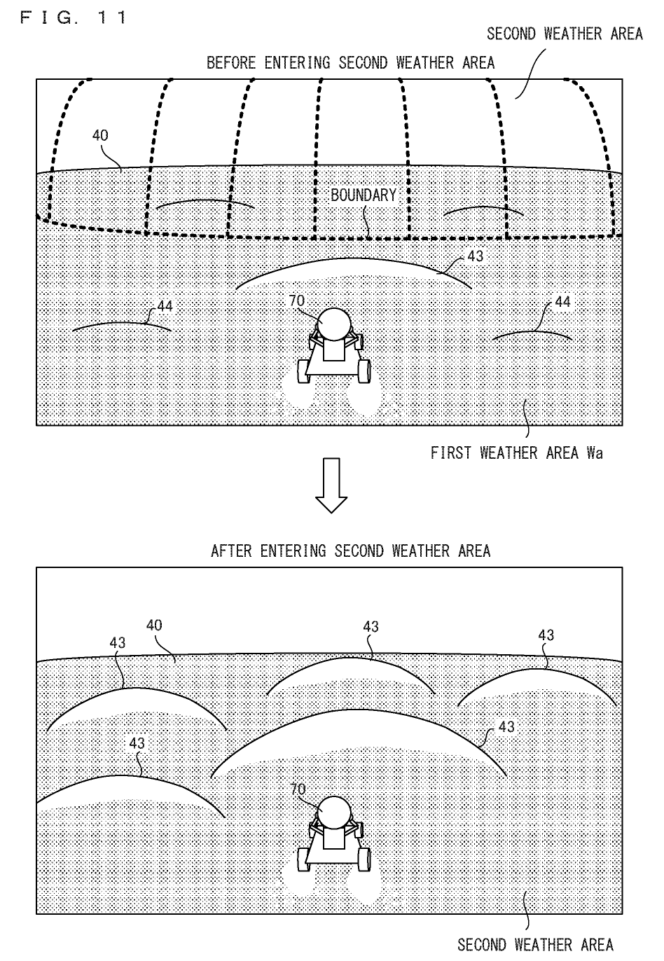

Here, a whitecap portion will be described. FIG. 9 illustrates a method for rendering a whitecap portion. As shown in FIG. 9, whitecaps are rendered within a predetermined range along the ridge line of the wave (a line connecting the wave peaks). Specifically, a texture image representing whitecaps is applied to a predetermined range including the ridge-line portion of the wave. For example, when the height of the ridge line exceeds a predetermined threshold and an inclination angle within a predetermined range including the ridge line (an inclination angle with respect to the XZ plane) exceeds a predetermined threshold, the texture image representing whitecaps is applied to the predetermined range. A texture image representing the water surface is applied to a portion of the water surface outside the predetermined range. For example, in a portion, of the first-type wave 43, outside the predetermined region, a texture image representing a wavy sea surface (blue first texture image) is applied. Meanwhile, in regions other than the first-type wave 43, such as an undeformed area or an area with only a small amount of deformation, a texture image representing a calm sea surface (blue second texture image) is applied. As a result, the portion of the wave on which the player object can perform a jump action can be displayed in a manner different from other portions, thereby allowing the player to visually recognize that a jump action is possible.

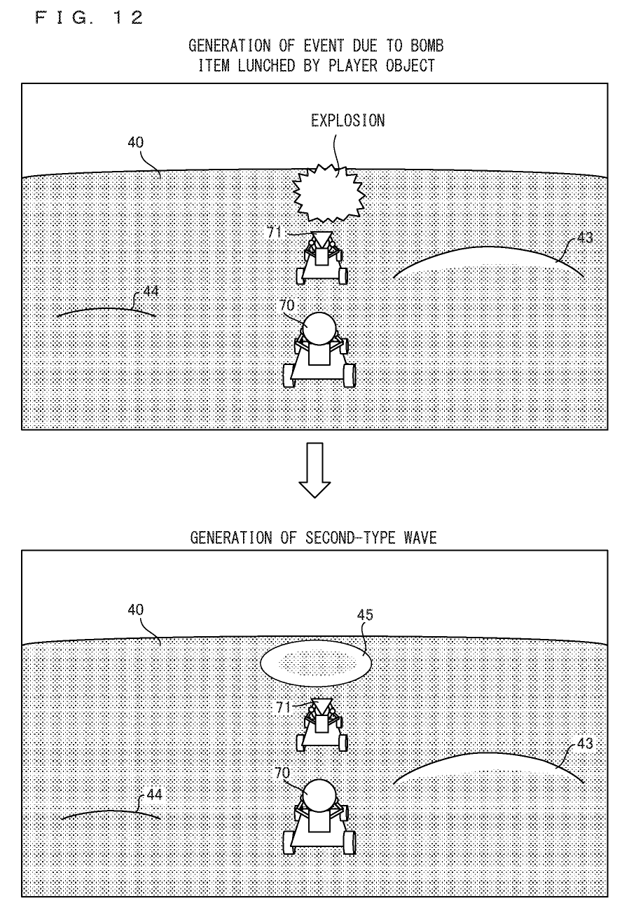

Next, a plurality of weather areas defined in the field will be described. FIG. 10 shows an example of a plurality of weather areas defined in the field.

As shown in FIG. 10, the field F is divided into a plurality of weather areas in advance. Specifically, in the field F, a plurality of first weather areas each having, for example, a cubic shape (square areas indicated by broken lines in FIG. 10) are defined. The shape of each first weather area is not limited to the cubic shape, and may be any shape such as a rectangular parallelepiped, a cone, or a triangular pyramid. A weather parameter is set for each first weather area. The weather parameter indicates, for example, the direction and strength of the wind. In addition, a second weather area having, for example, a hemispherical shape is defined in the field F. The shape of the second weather area is not limited to the hemispherical shape, and may be any shape such as a rectangular parallelepiped, a cone, or a triangular pyramid. Different weather parameters are set for the respective weather areas. Although the second weather area is included in a first weather area Wa having a cubic shape, if the player object is present in the second weather area, the weather parameter set for the second weather area is preferentially applied. Each main body apparatus 2 stores in advance the weather parameter set for each weather area.

Each main body apparatus 2 generates and controls waves according to a first determination method based on the weather parameter set for the weather area where the player object corresponding to the own apparatus is positioned, the shared random-number generation data, and the elapsed time from the predetermined start timing. Thus, when the player objects corresponding to main body apparatuses 2 are present in the same weather area, these main body apparatuses 2 generate waves in the same state at the same position. For example, as shown in FIG. 5 when the player object 70 corresponding to the first player and the opponent object 71 corresponding to the second player are close to each other and are traveling on the water surface, the same first-type waves as those shown in FIG. 5 are displayed on the display device of the main body apparatus 2 of the second player.

Depending on the strength and direction of the wind set for the weather area where the player object is present, the height of the generated waves and the direction in which the waves move (the direction in which the wave crests move) differ. For example, in the second weather area, a stronger wind is set than in the first weather area Wa. Therefore, when the player object 70 moves from the first weather area Wa into the second weather area, the wind strength changes, and the wave height also changes.

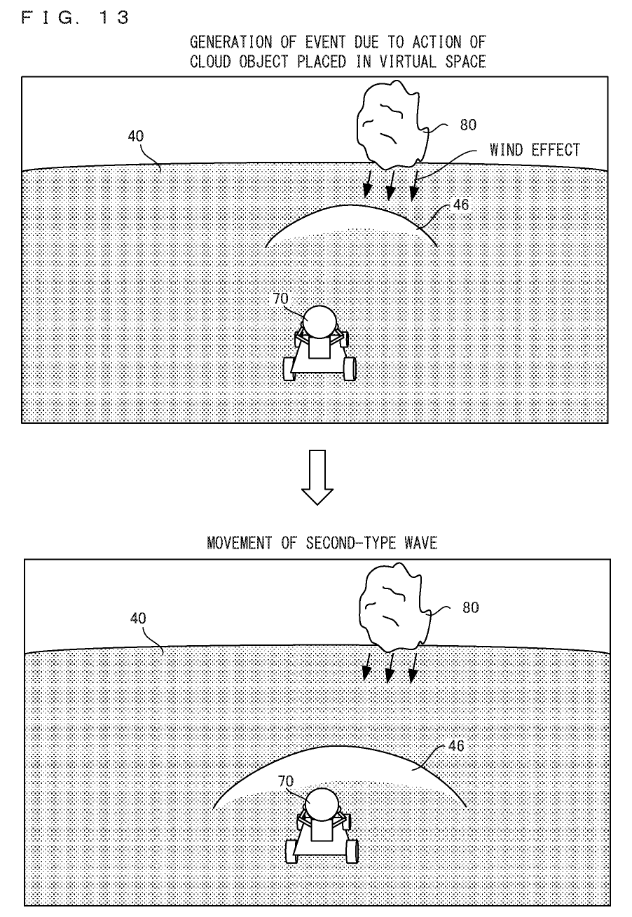

FIG. 11 shows an example of game images before and after the player object 70 enters the second weather area. In an upper part of FIG. 11, the player object 70 is positioned in the first weather area Wa. Since relatively weak wind is blowing in the first weather area Wa, the number of first-type waves 43 on which the player object 70 can perform a jump action is small, and the number of first-type waves 44 on which the player object 70 cannot perform a jump action is large.

When the player object 70 moves forward from the position shown in the upper part of FIG. 11, the player object 70 enters the second weather area (the lower part of FIG. 11). While the player object 70 is present in the second weather area, waves are generated and controlled in the second weather area, based on the weather parameter set for the second weather area. The weather parameter set for the second weather area indicates relatively strong wind. Therefore, as shown in the lower part of FIG. 11, in the second weather area where the player object 70 is present, the number of first-type waves 43 on which the player object 70 can perform a jump action is large.

On the water surfaces of the river 41 and the lake 42, waves based on weather parameters are generated in the same manner as that for the sea surface. In the river 41 and the lake 42, relatively large waves may be less likely to be generated, compared to the sea 40.

As described above, in the exemplary embodiment, a mobile object travels on the water surface of the sea, river, etc., and waves are generated and controlled at the water surface, based on the weather parameter set for each weather area. Therefore, it is possible to generate and control waves exhibiting regional characteristics according to the area of the field on which the player object 70 is traveling.

### Generation/Control of Second-Type Waves due to Occurrence of Event

In the exemplary embodiment, in addition to the first-type waves based on the weather parameters set for the weather areas described above, a second-type wave is generated based on a predetermined event. Hereinafter, generation of a second-type wave based on a predetermined event will be described. For example, the predetermined event includes: an event based on that the player object 70 or an opponent object has performed an action using a predetermined item; and an event based on that a predetermined character placed in the virtual space has performed an action.

FIG. 12 shows an example of a second-type wave that is caused by a bomb item launched by a player object. For example, during the racing game, when the player object 70 comes into contact with an item acquisition object placed in the virtual space, one of a plurality of types of items is given to the player object 70 at random. The plurality of types of items include, for example, an item that temporarily accelerates the player object 70, an item that interferes with traveling of an opponent object, and a bomb item that causes an explosion event.

For example, when an operation input for using an item is performed by the first player while the player object 70 holds a bomb item, the player object 70 executes an action of launching the bomb item into the virtual space. The launched bomb item moves through the virtual space, and an explosion event, in which the bomb item explodes, occurs after a predetermined time has elapsed or after the bomb item has traveled a predetermined distance. For example, as shown in an upper part of FIG. 12, the bomb item moves from the position of the player object 70 to a position ahead of the opponent object 71, and an explosion event occurs at the position. Then, as shown in a lower part of FIG. 12, a second-type wave 45 is generated from the position where the explosion event occurs.

The second-type wave 45 is a relatively high wave that spreads concentrically from the occurrence position of the explosion event, and is a wave on which a mobile object can perform a jump action. Therefore, the second-type wave 45 includes a whitecap portion (a white portion in FIG. 12). The second-type wave 45 is generated and controlled according to a second determination method based on the explosion event occurrence timing, the elapsed time (from the explosion event occurrence timing or the predetermined start timing), and the explosion event occurrence position.

Information on the occurrence timing and position of an explosion event is shared by a plurality of main body apparatuses 2. For example, when the player object 70 launches a bomb item, the main body apparatus 2 corresponding to the player object 70 determines the occurrence timing and position of an explosion event, and generates the explosion event at the determined occurrence timing and position. The main body apparatus 2 transmits information on the occurrence timing and position of the explosion event to the other main body apparatuses 2. Each main body apparatus 2 generates and controls a second-type wave 45, based on the shared occurrence timing and position of the explosion event, and the elapsed time.

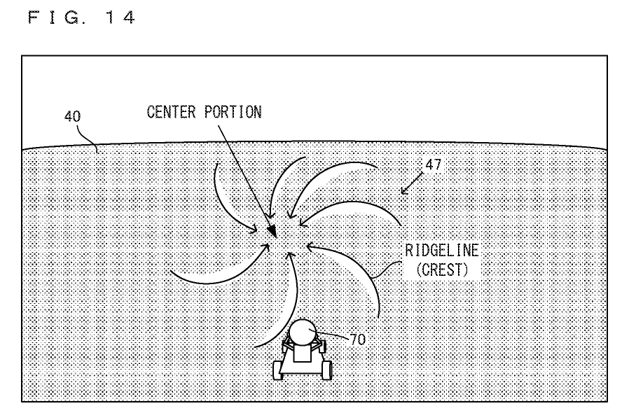

FIG. 13 shows an example of a second-type wave that is caused by an action performed by a cloud object placed in the virtual space. As shown in FIG. 13, a cloud object 80 is placed in the virtual space. The cloud object 80 is a character that causes a strong-wind event that generates a strong wind in a predetermined direction. For example, when the cloud object 80 performs a predetermined action, a strong-wind event is generated. The cloud object 80 may repeatedly generate the strong-wind event at predetermined time intervals. When the strong-wind event occurs, a wind effect is displayed, and a second-type wave 46 is generated.

The second-type wave 46 is a relatively high wave generated based on the cloud object 80 having performed a predetermined action, and is a wave on which a mobile object can perform a jump action. Therefore, a portion of the second-type wave 46 is rendered as whitecaps. The second-type wave 46 is generated and controlled according to a third determination method based on the execution timing of the predetermined action by the cloud object 80, the position where the action is performed, and the elapsed time (from the action execution timing or the predetermined start timing). For example, at the execution timing of the predetermined action, the second-type wave 46 is generated from a position based on the position where the action is performed (e.g., the placement position of the cloud object 80, or a position a certain distance away from the placement position). In addition, the second-type wave 46 moves in a direction according to the orientation of the cloud object 80.

Information on the execution timing of the predetermined action by the cloud object 80 and the position where the action is performed is shared by a plurality of main body apparatuses 2. Each main body apparatus 2 generates and controls a second-type wave 46, based on the shared execution timing and position of the predetermined action, and the elapsed time.

The shape of the second-type wave 46 may be the same as or different from the shape of the first-type waves 43.

In addition to the first-type wave based on the weather parameter set for each weather area and the second-type wave based on the predetermined event, various other waves are generated and controlled on the water surface.

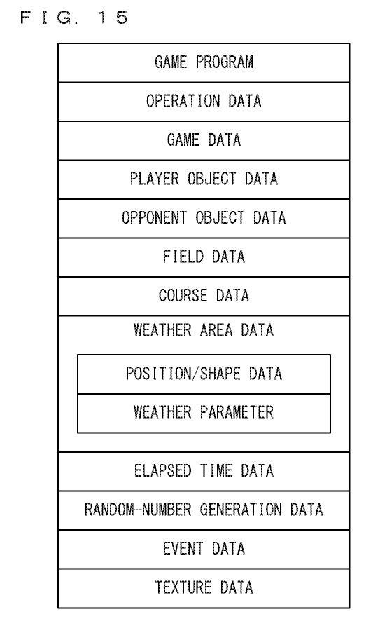

FIG. 14 shows an example of a whirlpool 47 placed at a predetermined position in the sea 40. The whirlpool 47 is a wave including a plurality of crest portions forming spiral-shaped ridgelines, and generates a flow that directs the mobile objects including the player object toward its central portion. For example, when the player object 70 remains stationary within a predetermined range from the center portion of the whirlpool 47, the player object 70 is moved toward the center portion along the ridgelines (the arrow in FIG. 14). The whirlpool 47 has a white portion (whitecaps) in a predetermined area along each ridgeline. The player object 70 may be allowed to perform a jump action when passing through the white portion of the whirlpool 47.

The whirlpool 47 may be formed by displacing the points on the water surface as described above. The shape of the whirlpool 47 does not change over time. The whirlpool 47 is fixed in the virtual space. The whirlpool 47 may be defined as a three-dimensional model different from an object representing the water surface, and may be placed on the object representing the water surface. The shape of the whirlpool 47 may change over time. The whirlpool 47 may move over time.

The mobile objects including the player object 70 travel on various water surfaces during the race. For example, during the race, a mobile object travels in a direction opposite to the flow of the river 41. At a predetermined position on the river 41, a waterfall having a predetermined height and inclination may be set, and when the mobile object passes through the waterfall at a predetermined speed or more, the mobile object may be allowed to perform a jump action. In a portion, of the waterfall on the river surface, where a mobile object can perform a jump action, whitecaps are rendered.

As described above, in the exemplary embodiment, in each of a plurality of main body apparatuses 2 that participate in a competitive race, the first-type waves are generated and controlled based on the weather parameters set for the weather areas. This makes it possible to generate appropriate waves according to the areas in the field.

### Details of Game Processing

Next, the details of the game processing performed in the game system 1 will be described. First, data used in the game system 1 will be described.

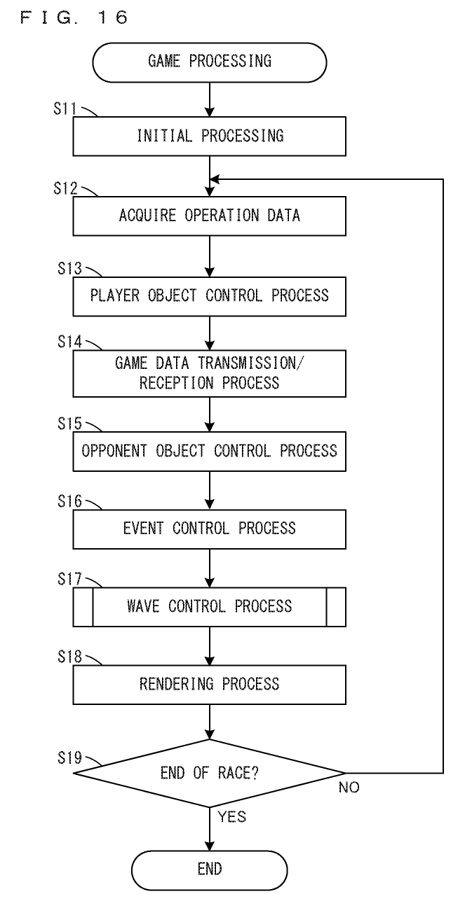

FIG. 15 shows an example of various data stored in the game system 1. As shown in FIG. 15, a game program, operation data, game data, player object data, opponent object data, field data, course data, weather area data, elapsed time data, random-number generation data, event data, and texture data are stored in the memory (e.g., the DRAM 27, the external storage medium attached to the slot 29, or the flash memory 26) of the game system 1.

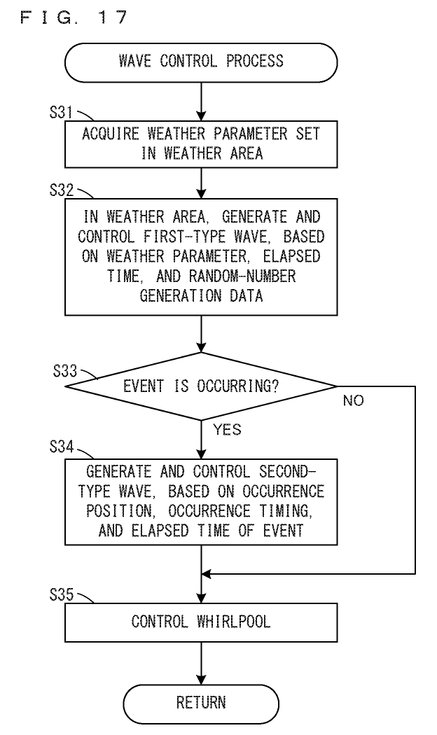

The game program includes instructions for executing processes described below (processes shown in FIGS. 16 and 17). The game program is stored in the external storage medium or the flash memory 26 in advance, and is loaded into the DRAM 27 when the game is played.

The operation data is data according to operations on the controller connected to the main body apparatus 2 wirelessly or via wire. The operation data is transmitted to the main body apparatus 2 from the controllers 3 and 4 at predetermined time intervals (e.g., intervals of 1/200 sec).

The game data is data received from another main body apparatus 2, and includes data regarding an opponent object operated by another player. For example, the game data includes data regarding the position, orientation, speed, movement direction, etc., of the opponent object. In addition, the game data includes data regarding items that the opponent object holds, data indicating that the opponent object has used an item (e.g., bomb item), and data regarding an action (e.g., jump action) performed by the opponent object.

The player object data is data regarding the player object 70 operated by the first player of the main body apparatus 2. The player object data includes data indicating the position, orientation, speed, movement direction, etc., of the player object 70, data regarding items that the player object 70 holds, data indicating that the player object 70 has used an item, and data regarding an action (e.g., jump action) performed by the player object 70.

The opponent object data is data regarding an opponent object (another player object) operated by another player. The opponent object data includes data regarding each opponent object (e.g., 71, 72). Specifically, the opponent object data includes data indicating the position, orientation, speed, movement direction, etc., of each opponent object, data regarding items that the opponent object holds, data indicating that the opponent object has used an item, and data regarding an action (e.g., jump action) performed by the opponent object.

The field data is data representing the entirety of the field F, and includes data representing the shape of the ground, and the shape of the water surface of the sea 40, the river 41, the lake 42, etc.

The course data is data indicating a course set in a portion of the field when a racing game is played, and includes data representing a route from the starting point to the goal point of the race.

The weather area data is data regarding each of a plurality of weather areas defined in the virtual space. The weather area data includes data regarding a plurality of first weather areas and data regarding a plurality of second weather areas. Specifically, the weather area data includes position/shape data representing the position and shape of each weather area, and the weather parameter set for the weather area.

The elapsed time data is data indicating an elapsed time from a predetermined start timing. The predetermined start timing may be the timing when a racing game is started, or the timing when a session of a multiplayer game is started (generated).

The random-number generation data is data for generating random numbers to be used for generating and controlling the above-described first-type waves. The random-number generation data is shared among a plurality of main body apparatuses 2.

The event data is data regarding various events that occur in the virtual space. For example, the event data includes data regarding an explosion event based on a bomb item, and data regarding a strong-wind event based on a predetermined action performed by the cloud object 80. Specifically, the event data includes information regarding the occurrence timing of each event, the occurrence position of each event, and the elapsed time (from the event occurrence timing or the predetermined start timing).

The texture data is data indicating a texture image applied to the ground and the water surface. The texture data includes data of a texture image representing the water surface, and data of a texture image representing whitecaps.

### Description of Flowchart

Next, a game processing performed in the game system 1 will be described. FIG. 16 is a flowchart showing an example of the game processing. The game processing is started when the player makes an instruction to start the game. In FIG. 16, a racing game is played in a multiplayer mode.

In the exemplary embodiment, the processor 21 of the main body apparatus 2 executes the game program using a memory (e.g., DRAM 27), thereby executing processes in steps shown in FIGS. 16 and 17. However, in other embodiments, some of the processes in the respective steps may be executed by a processor (e.g., a dedicated circuit) other than the processor 21. Some of the processes in the respective steps may be executed on another information processing apparatus (e.g., server). The processes in the respective steps are merely examples. As long as the same result is obtained, the processing order of the steps may be changed or another process may be executed in addition to (or instead of) the process in each step.

As shown in FIG. 16, first, the processor 21 executes initial processing (step S11). Here, various processes before starting a race are performed. For example, based on an operation input performed by the player, a process of participating in an online multiplayer session, and a process of determining and setting a course to be used for the race from among a plurality of courses respectively defined in partial regions of the field, are performed. Specifically, based on an instruction to start an online multiplayer race made by the player, the processor 21 transmits a participation request for an online multiplayer game to the server on the Internet. The server receives participation requests from a plurality of main body apparatuses 2, matches a plurality of players, and transmits a session ID to the main body apparatuses 2 of the matched players. Each main body apparatus 2 establishes communication (P2P communication) with the other main body apparatus 2, based on the session ID received from the server. In this case, one of the plurality of main body apparatuses 2 generates random-number generation data, and transmits the random-number generation data to the other main body apparatuses 2. Thus, the session start timing and the random-number generation data are shared between the plurality of main body apparatuses 2. After the communication between the plurality of main body apparatuses 2 has been established, based on a selection operation performed by each player, for example, one of the plurality of courses respectively defined in partial regions of the field is determined as a course to be used for the race. Then, the processor 21 sets the determined course, and starts the racing game after a predetermined time has elapsed.

When the racing game has started, the processor 21 acquires the operation data transmitted from the controllers 3 and 4 (step S12). Thereafter, the processor 21 repeatedly executes the processes in steps S12 to S19 at predetermined frame time intervals (e.g., intervals of 1/60 sec).

Next, the processor 21 executes a player object control process (step S13). Here, based on the operation data, the processor 21 updates the position, orientation, speed, movement direction, etc., of the player object 70, and causes the player object 70 to use an item. For example, the player object 70 launches a bomb item held by itself, into the virtual space, in response to an operation input performed by the player. In addition, when the player object 70 is riding on a wave and a jump-action permittable condition is satisfied, the processor 21 causes the player object 70 to perform a jump action, in response to a jump action instruction made by the player. For example, the jump-action permittable condition may include that the height and inclination angle of the crest of the wave on which the player object 70 is riding exceed thresholds, that the speed of the player object 70 exceeds a threshold, and that the player object 70 is positioned in the vicinity of the crest of the wave. When the player object 70 is caused to perform a jump action, the processor 21 temporarily increases the speed of the player object 70.

Next, the processor 21 executes a game data transmission/reception process (step S14). Specifically, the processor 21 receives game data from the other main body apparatus 2 through P2P communication based on the session ID. The game data received from the other main body apparatus 2 includes data indicating the position, orientation, speed, movement direction, etc., of the opponent object that is operated by the player of the other main body apparatus 2, data indicating that the opponent object has used an item (e.g., bomb item), data indicating that the opponent object has performed a jump action, the event data, etc. The processor 21 transmits, to the other main body apparatus 2, the game data according to the result of the player object control process in step S13 (e.g., data indicating the position, orientation, speed, movement direction, etc., of the player object 70, data indicating that the player object 70 has used an item, data indicating that the player object 70 has performed a jump action, etc.). The game data transmission/reception process in step S14 may be executed once every several to several tens of frames.

Next, the processor 21 executes an opponent object control process (step S15). Specifically, based on the game data received from the other main body apparatus 2 in step S14, the processor 21 updates the position, orientation, speed, movement direction, etc., of the opponent object, causes the opponent object to use an item, and causes the opponent object to perform a jump action.

Next, the processor 21 executes an event control process (step S16). Here, the processor 21 determines whether or not to generate one of various events, and generates the event when the determination result is positive. For example, the processor 21 causes the bomb item launched by the player object 70 in step S13 to move in the virtual space. When a predetermined time has elapsed from the launching of the bomb item or when the bomb item has traveled a predetermined distance, the processor 21 generates an explosion event. For a predetermined period after the occurrence of the explosion event, the game enters a state in which the explosion event is in progress. Also, the processor 21 causes the cloud object 80 placed in the virtual space to perform a predetermined action at a predetermined timing, thereby generating a strong-wind event. For a predetermined period from the occurrence of the strong-wind event, the game enters a state in which the strong-wind event is in progress. The event data regarding the event generated in the event control process (data regarding the occurrence position and timing of the event) is transmitted to the other main body apparatus 2.

Next the processor 21 executes a wave control process (step S17). The wave control process is a process of generating and controlling first-type waves and second-type waves. Hereinafter, the wave control process in step S17 will be described in detail.

### Wave Control Process

FIG. 17 is a flowchart showing an example of the wave control process in step S17.

As shown in FIG. 17, the processor 21 acquires weather parameters set in a weather area where the player object 70 is present (step S31).

Next, in an area where the player object 70 is present, the processor 21 generates and controls a first-type wave according to the first determination method based on the weather parameter, the elapsed time from the predetermined start timing, and the random-number generation data (step S32). The first determination method may be, for example, a method using a periodic function that includes, as variables, the weather parameter, the elapsed time, and the random-number generation data. Thus, a first-type wave is generated on the water surface of the area where the player object 70 is present, and the position (the position of the wave crest) and the state (height and shape) of the first-type wave are controlled over time. A plurality of first-type waves may be generated simultaneously at a plurality of locations. The waves generated at the plurality of locations may propagate across the water surface over time, and may interfere with each other or cancel each other out.

Next, the processor 21 determines whether an event is occurring (step S33). For example, the processor 21 determines whether an explosion event based on a bomb item is occurring, or whether a strong-wind event based on the cloud object 80 is occurring.

When such an event is occurring (step S33: YES), the processor 21 generates and controls a second-type wave, based on the occurrence position, occurrence timing, and elapsed time of the event (step S34). For example, when an explosion event is occurring (it is within a predetermined time from the occurrence of the explosion event), the processor 21 generates and controls a second-type wave 45 according to the second determination method based on the occurrence position, occurrence timing, and elapsed time of the explosion event. Meanwhile, when a strong-wind event due to the cloud object 80 is occurring, the processor 21 generates and controls a second-type wave 46 according to the third determination method based on the occurrence position, occurrence timing, and elapsed time of the strong-wind event. The elapsed time may be, for example, an elapsed time from the occurrence timing of each event, or an elapsed time from the predetermined start timing. A plurality of second-type waves may be simultaneously generated. A second-type wave and a first-type wave may be simultaneously generated. In this case, the plurality of waves may interfere with each other or cancel each other out.

When the process in step S34 has been executed or when the determination in step S33 is “NO”, the processor 21 controls a whirlpool placed at a predetermined position in the sea 40 (step S35). The whirlpool is a spiral wave having a flow toward a center portion thereof. If no whirlpool is placed in the field, step S35 is not executed.

When the process in step S35 has been performed, the processor 21 ends the wave control process shown in FIG. 17, and returns the processing to FIG. 16.

Referring back to FIG. 16, after the process in step S17, the processor 21 executes a rendering process (step S18). Here, the processor 21 generates a game image based on the virtual camera. Specifically, when the height and inclination angle of the wave are equal to or more than the thresholds, the processor 21 applies a texture image representing whitecaps to a predetermined range including the ridge-line portion of the wave. In addition, the processor 21 applies a texture image representing the water surface to a portion, of the water surface, outside the predetermined range. Thus, when the player object 70 is traveling on the water surface, a game image including an image of waves having whitecap portions as shown in FIG. 5, for example, is displayed.

Next, the processor 21 determines whether or not to end the race (step S19). For example, when all the mobile objects participating in the race have reached the goal, the processor 21 ends the race. When the determination result in step S19 is “NO”, the processor 21 executes the process in step S12 again. The racing game proceeds as the processes in steps S12 to S19 are repeatedly executed at predetermined frame time intervals (e.g., intervals of 1/60 sec).

The processes in the above flowchart are merely examples, and the order, contents, etc., of the processes may be appropriately changed.

As described above, the game system of the exemplary embodiment performs movement control for the player object on the field in the virtual space, based on an operation input (step S13). On the field, a plurality of weather areas for which virtual weather parameters are respectively set are defined (e.g., FIG. 10). When the position of the player object is within any one of the weather areas, the game system generates and controls, in the area, a first-type wave on which the player object can ride, and whose position and state are determined according to the first determination method at least based on the weather parameter set for the weather area and the elapsed time (step S32). When an instruction to start a race involving the player object and a plurality of opponent objects is made, the game system sets, on the field, a course to be used for the race, among a plurality of courses respectively defined in partial regions of the field, and starts the race. During the race, on the field, the game system performs movement control for the player object and movement control for the opponent objects along the course.

Thus, in a game in which races are conducted at various locations on the field, a wave can be appropriately generated and controlled for each area of the field. At the very least, a wave can be generated and controlled in at least the vicinity of the area where the player object is present, based on the weather parameter set for the area and the elapsed time. Even when the player object moves, an appropriate wave that reflects the weather parameter set for that location can be generated and controlled. Furthermore, when a competitive race involving a plurality of players is conducted, even if the player objects corresponding to the respective players are located far apart from one another, the weather settings for each area of the field can be shared, and a wave can be generated and controlled in each area.

In the exemplary embodiment, the first-type wave is generated and controlled according to the first determination method, based on the weather parameter for each weather area that is shared among a plurality of main body apparatuses 2, and the elapsed time synchronized among the plurality of main body apparatuses 2. Thus, even when a competitive race involving a plurality of players is conducted, control can be performed such that the same wave is generated at the same location at the same timing, thereby enabling a fair race.

In the exemplary embodiment, when a first action instruction is made based on an operation input at the timing when the player object moves and leaps over a wave, the player object is caused to perform the first action (e.g., jump action), and the player object is temporarily accelerated. This makes it possible to conduct the race while effectively using the waves.

In the exemplary embodiment, a predetermined range along a ridge-line portion of a wave is rendered as whitecaps. This makes it easier for the player to understand the position where the player can perform the first action.

The game system of the exemplary embodiment generates a first event (e.g., explosion event or strong-wind event) during a race, and generates and controls a second-type wave on which the player object can ride, and whose position and state are determined based on an occurrence timing of the first event that is shared with a computer of another player and an elapsed time that is synchronized with the computer of the other player. The first event may be an event in which an object on the field performs a second action. The second-type wave may be a wave that is generated at the position where the second action is performed at the timing when the second action is performed, and that moves based on the elapsed time. This makes it possible to generate the second-type wave that is different from the first-type wave based on the weather parameter.

### Modifications

While the exemplary embodiment has been described above, the above exemplary embodiment is merely an example, and the following modifications may be applied, for example.

For example, in the above exemplary embodiment, a wave is generated by deforming the shape of a water surface over time, and the wave is moved. In other embodiments, on a virtual model representing a water surface, a wave object, which is another three-dimensional virtual model, may be placed, and the wave object may be moved over time to move the wave.

In the above exemplary embodiment, a parameter indicating the direction and strength of wind is set as a weather parameter for each weather area, and based on the set weather parameter, an object such as grass or a flag is controlled and a wave is generated and controlled. In other embodiments, a wave parameter may be set as a weather parameter set for a weather area, and a wave may be generated and controlled based on the wave parameter.

In the above exemplary embodiment, the entirety of the field is divided into areas, and a weather parameter is set for each area. In other embodiments, an area for which a weather parameter is set and an area for which no weather parameter is set may exist in the field. If the player object is present in the area for which the weather parameter is set, a wave may be generated and controlled in this area, based on the weather parameter.

In the above exemplary embodiment, the wave on which the player object can ride generates an effect that is advantageous to traveling of the player object (e.g., effect of temporarily accelerating the player object). In other embodiments, the wave on which the player object can ride may generate an effect that is disadvantageous to traveling of the player object (e.g., effect of temporarily decelerating or stopping the player object).

In the above exemplary embodiment, a multiplayer racing game involving a plurality of players is played. In other embodiments, a free-traveling game in which the player object is allowed to freely travel on the field may be executed. A plurality of main body apparatuses 2 may participate in the same session, and a free-traveling game may be performed in the same virtual space. During execution of such a free-traveling game, wave generation and control may be performed according to the above-described method. For example, the plurality of main body apparatuses 2 each transmit a session participation request to the server, and the server generates a session based on the participation requests and transmits a session ID to each main body apparatus 2. Each main body apparatus 2 establishes communication based on the session ID. During the free-traveling game, each main body apparatus 2 generates and controls a first-type wave, based on the shared weather parameter for each weather area, the elapsed time from the start of the session, and the random-number generation data.

In the above exemplary embodiment, a plurality of main body apparatuses 2 share (store) in advance the weather parameter for each weather area. In other embodiments, the weather parameter for each weather area may be shared among a plurality of main body apparatuses 2 based on communication. For example, one of the plurality of main body apparatuses 2 may determine a weather parameter for each weather area, and when or after a session is established, may transmit the determined weather parameter for each weather area to the other main body apparatuses 2.

In the above exemplary embodiment, each main body apparatus 2 directly performs communication (P2P communication) during the race. In other embodiments, each main body apparatus 2 may perform communication via the server during the race.

In the above exemplary embodiment, waves are generated on the water surface of the sea, river, lake, etc. In other embodiments, waves may be generated and controlled in the manner described above not only on the water surface but also on the ground that deforms like fluid. For example, waves may be generated and controlled on the ground composed of sand or lava.

The above-described processes may be executed in any other information processing apparatus or information processing system, instead of the game system 1. The information processing system may be composed of a plurality of apparatuses, and the plurality of apparatuses may be connected via a network (e.g., LAN or the Internet).

The configurations according to the above exemplary embodiment and the modifications thereof may be combined together as desired as long as the configurations do not contradict each other. The above is merely an example of the exemplary embodiment, and various modifications and variations other than the above may be made.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to execute game processing comprising:
on a field in a virtual space, performing movement control for a player object based on an operation input, the field including a plurality of weather areas for which virtual weather parameters are respectively set;
when the player object is positioned within one of the weather areas, generating and controlling, within the area, a first-type wave on which the player object can ride, and whose position and state are determined according to a first determination method at least based on the weather parameter set for the weather area and an elapsed time; and
when an instruction to start a race involving the player object and a plurality of opponent objects is made,
setting, on the field, a course to be used for the race among a plurality of courses respectively defined in partial regions of the field, and starting the race, and
during the race, on the field, performing the movement control for the player object and movement control for the opponent objects along the course.

2. The one or more non-transitory computer-readable storage media according to claim 1, wherein
the race includes a competitive race involving a plurality of players, based on communication with a computer of another player, and
the game processing further comprises,
when an instruction to start the competitive race is made,
generating and controlling the first-type wave according to the first determination method, at least based on the weather parameter for each weather area that is shared with the computer of the other player in the competitive race, and the elapsed time that is synchronized with the computer of the other player in the competitive race.

3. The one or more non-transitory computer-readable storage media according to claim 2, wherein
the first determination method is a method for determining the position and state of the first-type wave, further based on random-number generation data, and
the game processing further comprises,
in the competitive race, generating and controlling the first-type wave according to the first determination method, further based on the random-number generation data that is shared with the computer of the other player.

4. The one or more non-transitory computer-readable storage media according to claim 2, wherein
the game processing further comprises,
when a first action instruction based on an operation input is made at a timing when the player object moves and leaps over the wave,
causing the player object to perform a first action, and temporarily accelerating the player object.

5. The one or more non-transitory computer-readable storage media according to claim 4, wherein
the game processing further comprises
rendering, as whitecaps, a range along a ridge-line portion of the wave.

6. The one or more non-transitory computer-readable storage media according to claim 2, wherein
the game processing further comprises,
during the competitive race,
generating a first event, and
generating and controlling a second-type wave on which the player object can ride, and whose position and state are determined based on an occurrence timing of the first event that is shared with the computer of the other player and the elapsed time that is synchronized with the computer of the other player.

7. The one or more non-transitory computer-readable storage media according to claim 6, wherein
the first event is an object on the field performing a second action, and
the second-type wave is a wave that is generated at a timing when the second action is performed, at a position where the second action is performed, and moves based on the elapsed time.

8. The one or more non-transitory computer-readable storage media according to claim 6, wherein
on the field, a whirlpool type wave is further arranged, the wave including crest portions forming a plurality of spiral-shaped ridgelines, the wave having a flow that controls the player object to move toward a center portion.

9. The one or more non-transitory computer-readable storage media according to claim 1, wherein
the weather parameter includes at least a direction and strength of a wind that is virtually set in the weather area, and
the game processing further comprises,
in the weather area including the player object,
generating and controlling the first-type wave, based on the direction and strength of the wind, and generating an effect of the virtual wind within the virtual space.

10. An information processing system comprising:
one or more processors; and
one or more non-transitory computer-readable media having stored therein instructions that, when executed, cause the one or more processors to execute game processing comprising:
on a field in a virtual space, performing movement control for a player object based on an operation input, the field including a plurality of weather areas for which virtual weather parameters are respectively set;
when the player object is positioned within one of the weather areas, generating and controlling, within the area, a first-type wave on which the player object can ride, and whose position and state are determined according to a first determination method at least based on the weather parameter set for the weather area and an elapsed time; and
when an instruction to start a race involving the player object and a plurality of opponent objects is made,
setting, on the field, a course to be used for the race among a plurality of courses respectively defined in partial regions of the field, and starting the race, and
during the race, on the field, performing the movement control for the player object and movement control for the opponent objects along the course.

11. The information processing system according to claim 10, wherein
the race includes a competitive race involving a plurality of players, based on communication with a computer of another player, and
the game processing further comprises,
when an instruction to start the competitive race is made,
generating and controlling the first-type wave according to the first determination method, at least based on the weather parameter for each weather area that is shared with the computer of the other player in the competitive race, and the elapsed time that is synchronized with the computer of the other player in the competitive race.

12. The information processing system according to claim 11, wherein
the first determination method is a method for determining the position and state of the first-type wave, further based on random-number generation data, and
the game processing further comprises,
in the competitive race, generating and controlling the first-type wave according to the first determination method, further based on the random-number generation data that is shared with the computer of the other player.

13. The information processing system according to claim 11, wherein
the game processing further comprises,
when a first action instruction based on an operation input is made at a timing when the player object moves and leaps over the wave,
causing the player object to perform a first action, and temporarily accelerating the player object.

14. The information processing system according to claim 13, wherein
the game processing further comprises
rendering, as whitecaps, a range along a ridge-line portion of the wave.

15. The information processing system according to claim 11, wherein
the game processing further comprises,
during the competitive race,
generating a first event, and
generating and controlling a second-type wave on which the player object can ride, and whose position and state are determined based on an occurrence timing of the first event that is shared with the computer of the other player and the elapsed time that is synchronized with the computer of the other player.

16. The information processing system according to claim 15, wherein
the first event is an object on the field performing a second action, and
the second-type wave is a wave that is generated at a timing when the second action is performed, at a position where the second action is performed, and moves based on the elapsed time.

17. The information processing system according to claim 15, wherein
on the field, a whirlpool type wave is further arranged, the wave including crest portions forming a plurality of spiral-shaped ridgelines, the wave having a flow that controls the player object to move toward a center portion.

18. The information processing system according to claim 10, wherein
the weather parameter includes at least a direction and strength of a wind that is virtually set in the weather area, and
the game processing further comprises,
in the weather area including the player object,
generating and controlling the first-type wave, based on the direction and strength of the wind, and generating an effect of the virtual wind within the virtual space.

19. A computer-implemented method comprising:
on a field in a virtual space, performing movement control for a player object based on an operation input, the field including a plurality of weather areas for which virtual weather parameters are respectively set;
when the player object is positioned within one of the weather areas, generating and controlling, within the area, a first-type wave on which the player object can ride, and whose position and state are determined according to a first determination method at least based on the weather parameter set for the weather area and an elapsed time; and
when an instruction to start a race involving the player object and a plurality of opponent objects is made,
setting, on the field, a course to be used for the race among a plurality of courses respectively defined in partial regions of the field, and starting the race, and
during the race, on the field, performing the movement control for the player object and movement control for the opponent objects along the course.

20. The computer-implemented method according to claim 19, wherein
the race includes a competitive race involving a plurality of players, based on communication with a computer of another player, and
the method further comprises,
when an instruction to start the competitive race is made,
generating and controlling the first-type wave according to the first determination method, at least based on the weather parameter for each weather area that is shared with the computer of the other player in the competitive race, and the elapsed time that is synchronized with the computer of the other player in the competitive race.

21. The computer-implemented method according to claim 20, wherein
the first determination method is a method for determining the position and state of the first-type wave, further based on random-number generation data, and
the method further comprises,
in the competitive race, generating and controlling the first-type wave according to the first determination method, further based on the random-number generation data that is shared with the computer of the other player.

22. The computer-implemented method according to claim 20, further comprising,
when a first action instruction based on an operation input is made at a timing when the player object moves and leaps over the wave,
causing the player object to perform a first action, and temporarily accelerating the player object.

23. The computer-implemented method according to claim 22, further comprising
rendering, as whitecaps, a range along a ridge-line portion of the wave.

24. The computer-implemented method according to claim 20, further comprising,
during the competitive race,
generating a first event, and
generating and controlling a second-type wave on which the player object can ride, and whose position and state are determined based on an occurrence timing of the first event that is shared with the computer of the other player and the elapsed time that is synchronized with the computer of the other player.

25. The computer-implemented method according to claim 24, wherein
the first event is an object on the field performing a second action, and
the second-type wave is a wave that is generated at a timing when the second action is performed, at a position where the second action is performed, and moves based on the elapsed time.

26. The computer-implemented method according to claim 24, wherein
on the field, a whirlpool type wave is further arranged, the wave including crest portions forming a plurality of spiral-shaped ridgelines, the wave having a flow that controls the player object to move toward a center portion.

27. The computer-implemented method according to claim 19, wherein
the weather parameter includes at least a direction and strength of a wind that is virtually set in the weather area, and
the method further comprises,
in the weather area including the player object,
generating and controlling the first-type wave, based on the direction and strength of the wind, and generating an effect of the virtual wind within the virtual space.
